(19) United States
(12) Patent Application Publication
(10) Pub. No.: US 2018/0288556 A1
(43) Pub. Date: Oct. 4, 2018

(54) AUDIO OUTPUT DEVICE, AND METHOD FOR CONTROLLING AUDIO OUTPUT DEVICE

(71) Applicant: SAMSUNG ELECTRONICS CO., LTD., Suwon-si (KR)

(72) Inventor: Bo-hyun KYUNG, Seongnam-si (KR)

(73) Assignee: SAMSUNG ELECTRONICS CO., LTD., Suwon-si (KR)

(21) Appl. No.: 15/765,102

(22) PCT Filed: Sep. 20, 2016
(86) PCT No.: PCT/KR2016/010456

§ 371 Date: Mar. 30, 2018

(30) Foreign Application Priority Data
Oct. 1, 2015 (KR) 10-2015-0138767

(51) Int. Cl. H04S 7/00; H04S 3/00; H04R 5/02

(52) U.S. Cl. CPC H04S 7/303; H04S 3/008; H04S 2400/11; H04S 2400/01; H04R 5/02

(57) ABSTRACT

Disclosed is an audio output device. The audio output device comprises: an audio processing unit for processing audio signals having a plurality of channels; a plurality of speakers for outputting the processed audio signals having a plurality of channels; a position information acquisition unit for acquiring position information of a listener; and a processor for controlling the audio processing unit to mix, on the basis of the position information of the listener, an audio signal of a channel corresponding to at least one speaker from among the plurality of speakers with an audio signal of another channel.

### TECHNICAL FIELD

The present disclosure relates to an audio output device and a method of controlling the audio output device, and more particularly, to an audio output device for and an audio output method of processing an audio signal based on position information of listener.

### BACKGROUND ART

With the development of electronic technology, various types of audio output devices have been developed. In particular, to meet the needs of listeners who want to listen to more stereoscopic sounds, beyond 2-channel stereo techniques, techniques that may provide surround stereophonic sounds, such as 4-channel, 5.1-channel, 7.1-channel, and the like, are emerging.

However, in a conventional sound system using a multi-channel stereophonic sound providing technique, an audio signal of each channel is directly output to a speaker of each channel that is fixed during initial installation of an audio output device. Thus, when a listener listens to a sound at a position close to one speaker of a plurality of speakers, the listener often fails to hear the sound output from a speaker far from the listener.

Furthermore, for example, in the case of a sound bar, the listener has to hear sound exactly at a reference position corresponding to the center of the sound bar to hear optimum sound. When the listener moves out of the reference position, the listener cannot listen to the optimum sound.

Accordingly, there is a growing need for a technique that may output audio based on information about a position of a listener or the number of listeners in a multi-channel audio output device or system.

### DESCRIPTION OF EMBODIMENTS

### Technical Problem

The present disclosure is devised in accordance with the above-described needs, and is directed to an audio output device and an audio output method capable of providing optimized audio sound according to position of a listener.

### Solution to Problem

An audio output device according to an aspect of the present disclosure includes an audio processing unit configured to process an audio signal having a plurality of channels, a plurality of speakers configured to output the processed audio signal having the plurality of channels, a position information acquisition unit configured to acquire position information of a listener, and a processor configured to control the audio processing unit to mix an audio signal of a channel corresponding to at least one speaker from among the plurality of speakers with an audio signal of another channel, based on the position information of the listener.

The processor may determine a distance between each of the plurality of speakers and the listener using the position information of the listener, and control the audio processing unit to mix an audio signal of a channel corresponding to at least one speaker, which is relatively close to the listener from among the plurality of speakers, with the audio signal of the another channel.

The processor may control the audio processing unit to multiply the audio signal of the another channel by a higher weight as a distance between a speaker corresponding to the audio signal of the another channel and the listener increases, and mix the multiplied audio signal.

The processor may control the audio processing unit to provide the mixed audio signal to the at least one speaker and provide the audio signal of the another channel to a speaker corresponding to the another channel.

The plurality of channels may be two channels, and the plurality of speakers may include a left channel speaker and a right channel speaker. The processor may control the audio processing unit to mix an audio signal of the left channel with an audio signal of the right channel if the listener is located relatively close to the left channel speaker, and mix the audio signal of the right channel with the audio signal of the left channel if the listener is located relatively close to the right channel speaker.

The plurality of channels may be five channels, and the plurality of speakers may include first to fifth channel speakers arranged in line in sequential order. The processor may control the audio processing unit to mix an audio signal of the first channel with audio signals of fourth and fifth channels and mix an audio signal of the second channel with the audio signal of the fifth channel if the listener is located closest to the first channel speaker, and may control the audio processing unit to mix the audio signal of the second channel with the audio signal of the fifth channel if the listener is located closest to the second channel speaker.

If a plurality of listeners are present, the processor may control the audio processing unit not to mix the audio signal of the another channel.

If a plurality of listeners are present, the processor may select a listener to acquire the position information, from among the plurality of listeners, according to predetermined criteria and control the position information acquisition unit to acquire position information of the selected listener.

The processor may select the listener to acquire the position information on the basis of a user selection command for selecting the listener to acquire the position information or a position of a specific external apparatus.

A method of controlling an audio output device including a plurality of speakers corresponding to a plurality of channels according to an aspect of the present disclosure includes acquiring position information of a listener and mixing an audio signal of a channel corresponding to at least one speaker from among the plurality of speakers with an audio signal of another channel based on the position information of the listener.

The mixing of the audio signals may include determining a distance between each of the plurality of speakers and the listener using the position information of the listener, and mixing an audio signal of a channel corresponding to at least one speaker, which is relatively close to the listener from among the plurality of speakers, with the audio signal of the another channel.

The mixing of the audio signals may include multiplying the audio signal of the another channel by a higher weight as a distance between a speaker corresponding to the audio signal of the another channel and the listener increases, and mixing the multiplied audio signal.

The method may further include providing the mixed audio signal to the at least one speaker and providing the audio signal of the another channel to a speaker corresponding to the another channel.

The plurality of channels may be two channels, and the plurality of speakers may include a left channel speaker and a right channel speaker. The mixing of the audio signals may include mixing an audio signal of the left channel with an audio signal of the right channel if the listener is located relatively close to the left channel speaker and mixing the audio signal of the right channel with the audio signal of the left channel if the listener is located relatively close to the right channel speaker.

The plurality of channels may be five channels, and the plurality of speakers may include first to fifth channel speakers arranged in line in sequential order. The mixing of the audio signals may include mixing an audio signal of the first channel with audio signals of fourth and fifth channels and mixing an audio signal of the second channel with the audio signal of the fifth channel if the listener is located closest to the first channel speaker, and mixing the audio signal of the second channel with the audio signal of the fifth channel if the listener is located closest to the second channel speaker.

if the plurality of listeners are present, the method may further include not mixing the audio signal of the another channel.

if the plurality of listeners are present, the method may further include selecting a listener to acquire the position information, from among the plurality of listeners, according to predetermined criteria. The acquisition of the position information may include acquiring position information of the selected listener.

The selecting of the listener to acquire the position information may include selecting the listener to acquire the position information on the basis of a user selection command for selecting the listener to acquire the position information or a position of a specific external apparatus.

In a non-transitory computer readable medium having recorded thereon a program for performing a method of controlling an audio output device including a plurality of speakers corresponding to a plurality of channels, according to an embodiment of the present disclosure, the method includes acquiring position information of a listener and mixing an audio signal of a channel corresponding to at least one speaker from among a plurality of speakers with an audio signal of another channel based on the position information of the listener.

### Advantageous Effects of Disclosure

According to various embodiments of the present disclosure described above, even if a position of a listener is changed, the listener can listen to optimum sound provided by an audio output device at a changed position.

### BRIEF DESCRIPTION OF DRAWINGS

FIG. 1 is a block diagram of a configuration of an audio output device according to an embodiment of the present disclosure,

FIG. 2 is a detailed block diagram of a configuration of an audio output device according to an embodiment of the present disclosure,

FIGS. 3 to 5 are exemplary diagrams for describing operations of an audio output device according to an embodiment of the present disclosure,

FIG. 6 is a detailed block diagram of a configuration of an audio output device according to another embodiment of the present disclosure,

FIG. 7 is an exemplary diagram of an audio output device including the configuration shown in FIG. 6,

FIG. 8 is an exemplary diagram for describing an operation of an audio output device according to an embodiment of the present disclosure when a plurality of listeners are present,

FIG. 9 is an exemplary diagram for describing an operation of an audio output device according to an embodiment of the present disclosure when a plurality of speakers are located on a space, and

FIG. 10 is a flowchart of a method of controlling an audio output device according to an embodiment of the present disclosure.

### BEST MODE

In the description of the present disclosure, detailed descriptions of related known techniques are omitted when it is determined that the detailed descriptions may unnecessarily obscure the gist of the present disclosure. A term “unit” for components used in the following descriptions is given or mixed in consideration of only ease of specification, and does not have a meaning or function that distinguishes itself.

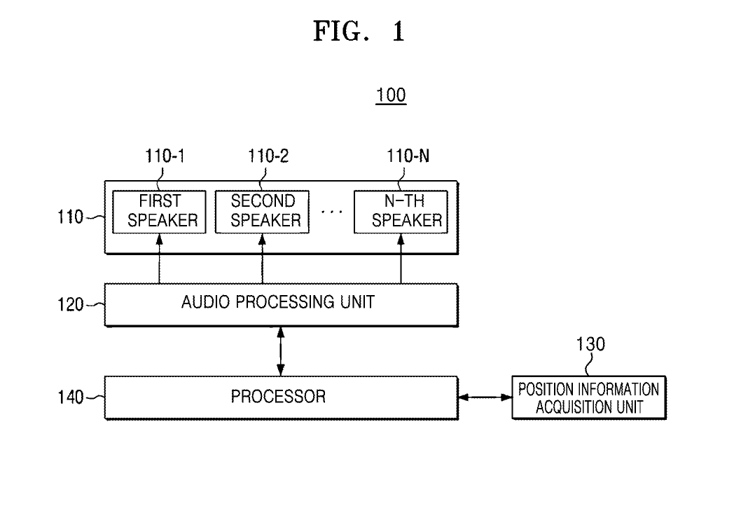

Various embodiments of the present disclosure will now be described in detail with reference to the accompanying drawings. FIG. 1 is a block diagram of a configuration of an audio output device according to an embodiment of the present disclosure. Referring to FIG. 1, an audio output device 100 includes a plurality of speakers 110, an audio processing unit 120, a position information acquisition unit 130, and a processor 130. In this case, the audio output device 100 may be implemented as a sound bar, a television (TV), an electronic frame, an electronic board, a laptop computer, a table display, a large format display (LFD), or the like.

The plurality of speakers 110 correspond to a plurality of channels and output an audio signal having the plurality of channels, which is processed by the audio processing unit 120. In the example of FIG. 1, from among the plurality of channels, a first speaker 110-1 may corresponding to the first channel, a second speaker 110-2 may correspond to a second channel, and an N-th speaker 110-N may correspond to an N-th channel. Also, N is equal to or more than 2.

The audio processing unit 120 performs various processing operations on an input audio signal and output the processed audio signal to the plurality of speakers 110. Specifically, the audio processing unit 120 may perform various processing operations, such as a decoding operation, an amplification operation, a noise filtering operation, and an equalizing operation, on the input audio signal. In this case, an audio signal input to the audio processing unit 120 may be an audio signal having a plurality of channels, and the audio processing unit 120 may process the audio signal having the plurality of channels and provide the processed audio signal to each of the plurality of speakers 110. Particular, the audio processing unit 120 may mix an audio signal of any one of the plurality of channels with an audio signal of another channel via the control of the processor 140.

The position information acquisition unit 130 may acquire position information of a listener. For example, when the position information acquisition unit 130 includes an image sensor, the position information acquisition unit 130 may acquire position information of a listener through an image frame acquired by the image sensor.

However, the configuration of the position information acquisition unit 130 is not limited thereto, and any unit by which the position information of the listener may be acquired may be a component of the position information acquisition unit 130. For example, the position information of the listener may be acquired using a manipulation signal of a remote control device, such as a remote controller. Alternatively, the position information of the listener may be acquired using a Bluetooth signal or a WiFi signal transmitted from a specific electronic device (e.g., a cellphone, an electronic watch, or the like) carried by the listener. Also, in some embodiments, position information of a specific listener may be acquired using a voice recognition technique.

To this end, the position information acquisition unit 130 may be implemented as including various configurations, such as an infrared (IR) signal receiving module, a Bluetooth communication module, a WiFi communication module, a GPS communication unit module, a voice recognition module including at least one microphone, and the like.

The processor 140 controls the overall operations of the audio output device 100.

Specifically, the processor 140 may output sound source data, which is input to the audio output device 100, to the audio processing unit 120. In this case, the processor 140 may process the sound source data as an audio signal having a plurality of channels and output the processed sound source data. Specifically, when the sound source data itself is sound source data recorded as a plurality of channels, the processor 140 may output the corresponding sound source data directly to the audio processing unit 120 as an audio signal having a plurality of channels. Also, even if the sound source data itself is not recorded as the plurality of channels, in some embodiments, the processor 140 may separate sound, convert the separated sound into an audio signal having a plurality of channels, and output the audio signal having the plurality of channels to the audio processing unit 120.

In addition, the processor 140 may control the audio processing unit 120 to mix an audio signal of a channel corresponding to at least one speaker from among the plurality of speakers 110 with an audio signal of another channel, based on the position information of the listener acquired by the position information acquisition unit 120.

Specifically, as described below, the processor 140 may determine a distance between each of the plurality of speakers 110 and the listener using the position information of the user, which is acquired by the position information acquisition unit 130. However, the inventive concept is not limited thereto. In some embodiments, the position information acquisition unit 130 may determine a distance between each of the plurality of speakers 110 and the listener and provide the determination result to the processor 140.

Thus, the processor 140 may control the audio processing unit 120 to mix an audio signal of a channel corresponding to at least one speaker, which is relatively close to the listener from among the plurality of speakers, with an audio signal of another channel.

In addition, the processor 140 may provide the mixed audio signal to each of the at least one speaker, which is relatively close to the listener. The processor 140 may control the audio processing unit 120 to provide the mixed audio signal of the another channel to a speaker corresponding to each of other channels.

For example, in a situation in which the audio output device 100 includes a 2-channel speaker including a first channel speaker and a second channel speaker and a 2-channel audio signal is provided to each of the first and second channel speakers, when the listener is located relatively close to the first channel speaker, the processor 140 may control the audio processing unit 120 to mix a first channel audio signal with a second channel audio signal. Thus, the processor 140 may control the audio processing unit 120 to provide an audio signal obtained by mixing the first channel audio signal with the second channel audio signal to the first channel speaker and to provide the second channel audio signal directly to the second channel speaker.

Meanwhile, when a plurality of listeners are present, the processor 140 may control the audio processing unit 200 not to mix audio signals of other channels. Specifically, the processor 140 may analyze listener position information acquired by the position information acquisition unit 130 and determine whether listeners are plural or not. For example, when the position information acquisition unit 130 includes an image sensor (not shown), the position information acquisition unit 130 may acquire an image frame including the listener using the image sensor. Thus, the processor 140 may analyze an image frame acquired by the image sensor and determine whether the listeners are plural or not. Therefore, when the listeners are determined to be plural, the processor 140 may control the audio processing unit 220 not to mix audio signals but to directly provide an audio signal corresponding to each channel to each channel speaker.

However, an embodiment in which a plurality of listeners are present is not limited thereto. For example, when the plurality of listeners are present, the processor 240 may select one listener to acquire position information according to predetermined criteria and control the position information acquisition unit 130 to acquire position information of the selected listener. Specifically, the processor 140 may select a listener to acquire position information, based on a user command for selecting a user to acquire position information or a position of a specific external apparatus.

For instance, when criteria for selecting a listener to acquire position information are set in response to the user command, the processor 140 may control the position information acquisition unit 130 to acquire position information of a listener selected by a user from among a plurality of listeners. In this case, when a position of the listener selected by the user is moved, the processor 140 may control the position information acquisition unit 130 to track the moved listener using a position tracking technique and acquire position information of the listener.

Meanwhile, when criteria for selecting a listener to acquire position information are set to be based on a holder of a specific external apparatus, for example, a remote controller or a cellphone, the processor 140 may acquire position information of the external apparatus using various signals (an IR signal, a Bluetooth signal, a WiFi signal, and the like depending on a type of the external apparatus) transmitted by the corresponding external apparatus, and acquire position information of the listener.

Thereafter, the processor 140 may control the audio processing unit 120 to mix an audio signal of a channel corresponding to at least one speaker from among the plurality of speakers 110 with an audio signal of another channel based on the position information of the selected listener, which is acquired as described above.

Generally, in the case of the audio output device 100 including two channel speakers, an optimum audio listening environment is produced at the center of each of the channel speakers. That is, when the listener is located at a center between first and second channel speakers, it is generally possible to listen to a sound source reproduced with optimum sound. Here, the listener may move and be located close to a side of the first channel speaker. In this case, since the listener is relatively far from the second channel speaker, a second channel audio signal output through the second channel speaker may sound tiny to the listener as much as the listener is away from the second channel speaker or may not be heard in some cases.

According to the embodiment of the present disclosure, which is described above with reference to FIG. 1, the second channel audio signal, which sounds tiny to the listener as the listener is away from the second channel speaker, is mixed with a first channel audio signal, and the mixed audio signal is output from the first channel speaker. Thus, the second channel audio signal output from the second channel speaker that becomes away from the listener may be supplemented. Accordingly, an optimum audio listening environment may be provided irrespective of a position of the listener.

Meanwhile, the audio output device 100 shown in FIG. 1 is not necessarily configured with a single device. For example, the audio processing unit 120, the position information acquisition unit 130, and the processor 140 may be included in a television (TV), a personal computer (PC), a laptop computer, a cellphone, or the like. An audio output system configured to output audio signals having a plurality of channels through the plurality of speakers 110 connected to the audio processing unit 120, the position information acquisition unit 130, and the processor 140 may also fall under the category of the audio output device 100 according to the present disclosure.

That is, even if respective components of an audio output device described in the present specification are included in different devices, when the components are connected to each other through the respective devices and capable of operating as in various embodiments of the present disclosure, the overall system including the respective components may also be an audio output device according to the present disclosure.

Although it is assumed with reference to FIG. 1 that the audio processing unit 120 and the processor 140 are separate components, the present disclosure is not limited thereto. In some embodiments, operations of the audio processing unit 120 may be performed together by the processor 140.

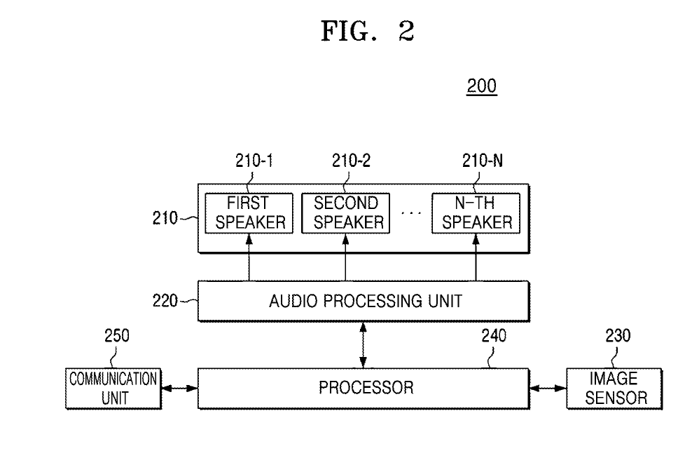

FIG. 2 is a block diagram of a detailed configuration of an audio output device according to an embodiment of the present disclosure. Referring to FIG. 2, an audio output device 200 includes a plurality of speakers 210, an audio processing unit 220, an image sensor 230, a processor 240, and a communication unit 250. In FIG. 2, since the plurality of speakers 210 and the audio processing unit 220 have the same configurations as the plurality of speakers 110 and the audio processing unit 120 described with reference to FIG. 1, repeated descriptions thereof are omitted.

The image sensor 230 captures an external image and acquires an image frame. Particularly, the image sensor 230 may be located to capture an image of a listening region in which listeners are mainly located, and capture images including the listeners. Also, the image sensor 230 may capture an image including the listeners by predetermined frame units via the control of the processor 240. When a plurality of listeners are present, the image sensor 230 may track a specific listener and capture an image of the specific listener. Accordingly, the image sensor 230 may acquire an image frame including the listener in the listening region and acquire position information of the image listener. The acquired image frame including the listener may be provided to the processor 140 and subsequently used to determine a distance between each of the plurality of speakers and the listener using the processor 140.

In this case, one image sensor 230 may be located adjacent to each of the plurality of speakers 210, and at least one image sensor 230 may be located in the center of the audio output device 200. Also, when an additional external device (e.g., the audio output device 200) is a sound bar, the sound bar may be located in an additional display device (or an additional external camera and the like) used together with the sound bar. The sound bar may capture an image of the image frame including the listener, acquire position information of the listener, and provide the position information of the listener to the audio output device 200.

The communication unit 250 communicates with an external device. Specifically, the communication unit 250 may receive, from various sources, sound source data to be output to the plurality of speakers 210. In this case, the sound source data may be obtained from various sources, such as a sound source stored in an external storage device (e.g., a universal serial bus (USB), a compact disk (CD) player, and a digital versatile disk (DVD) player) or a storage unit (not shown) of the audio output device 200 or a sound source provided by a sound source server operated by a contents provider (CP) configured to provide various contents (e.g., broadcasting contents) and a broadcasting station.

To this end, the communication unit 230 may include at least one communication module of a short-range wireless communication module (not shown) and a wireless local area network (LAN) communication module (not shown). Here, the short-range wireless communication module (not shown) may be a communication module configured to wirelessly perform data communication with an external device located in a short distance. For example, the short-range wireless communication module (not shown) may be a Bluetooth module, a Zigbee module, a near-field communication (NFC) module, or the like. Also, the wireless LAN communication module (not shown) may be a module connected to an external network according to a wireless communication protocol (e.g., WiFi and IEEE) and perform communication. In addition, the communication unit 230 may further include a mobile communication module connected to a mobile communication network according to various mobile communication standards (e.g., 3^{rd} generation (3G), 3^{rd} generation partnership project (3GPP), and long-term evolution (LTE)) and perform communication. Furthermore, the communication unit 2350 may include at least one of wired communication modules (not shown), such as a high-definition multimedia interface (HDMI), a USB, institute of electrical and electronics engineers (IEEE) 1394, recommended standard (RS)-232, and the like.

In this case, sound source data received through the communication unit 230 may be sound source data obtained by recording a sound source itself via a plurality of channels, but the present disclosure is not limited thereto.

Further, according to an embodiment of the present disclosure, when position information of a listener is acquired in response to a remote control signal, a Bluetooth signal, a WiFi signal, a global positioning system (GPS) signal, and a radio-frequency identification (RFID) signal, the communication unit 230 may acquire the position information of the listener. In this case, the communication unit 230 performs functions of the position information acquisition unit 130 in the example of FIG. 1. To this end, the communication unit 230 may further include at least one of an IR signal receiving module, a GPS communication module, and an RFID communication module.

The processor 240 controls the overall operations of the audio output device 200. Specifically, the processor 240 processes a plurality of pieces of sound source data received through the communication unit 230 and provide an audio signal having a plurality of channels to the audio processing unit 220. Thus, the audio processing unit 220 may perform various processing operations on the audio signal having the plurality of channels via the control of the processor 240.

In addition, the processor 240 may determine a distance between each of the plurality of speakers 210 and the listener using the position information of the listener. For example, the processor 240 may analyze an image frame including a listener, which is acquired by the image sensor 230, using known various methods and determine a relative or absolute distance between each of the plurality of speakers and the listener. That is, the processor 240 may determine which one of the plurality of speakers 210 is closer or farther to the listener.

In addition, when the position information of the listener is acquired by the communication unit 250 according to another embodiment of the present disclosure, as described above, the processor 140 may analyze an IR signal transmitted by a remote controller carried by the listener or a Bluetooth signal, a WiFi signal, or an RFID signal transmitted by a specific electronic device (e.g., a portable phone and an electronic watch) transmitted by a remote controller carried by the listener, and determine a distance between each of the plurality of speakers 210 and the listener.

Furthermore, according to another embodiment of the present disclosure, when the listener carries an electronic device, such as a cellphone including a GPS module, a WiFi module, a Bluetooth module, and the like, the corresponding electronic device may transmit its own position information to the audio output device 200, and the processor 240 may determine a distance between each of the plurality of speakers 210 and the listener based on the position information of the electronic device, which is received through the communication unit 250.

The above-described various methods of determining position information may be combined and used to increase accuracy of determination of a distance between each of the plurality of speakers 210 and the listener.

Generally, since positions of the plurality of speakers 210 are fixed during the initial installation of the audio output device 100, the distance between each of the plurality of speakers 210 and the listener may be determined without great difficulty by acquiring the position information of the listener.

Meanwhile, the processor 240 may control the audio processing unit 220 to mix audio signals of a plurality of channels corresponding respectively to the plurality of speakers 210 based on the determined distance between each of the plurality of speakers 210 and the listener.

Specifically, the processor 240 may control the audio processing unit 220 to mix an audio signal of a channel corresponding to at least one speaker, which is relatively close to the listener from among the plurality of speakers 210, with an audio signal of another channel.

In this case, the mixed audio signal of the another channel may be multiplied by a weight value of between 0 and 1 and mixed.

For example, the audio output device 200 may include five channel speakers including first to fifth channel speakers arranged in line, and five channel audio signals may be provided to the respective speakers corresponding thereto. In this case, if the listener is located closest to the first channel speaker, since the five speakers are located in line, a distance between the listener and a channel speaker increases toward a fifth channel and away from a second channel.

Accordingly, the processor 240 may control the audio processing unit 220 to mix a first channel audio signal corresponding to the first channel speaker, which is located closest to the listener, with a fourth channel audio signal and a fifth channel audio signal. The processor 240 may control the audio processing unit 220 to mix a second channel audio signal corresponding to a second channel speaker, which is located second closest to the listener, with a fifth channel audio signal. In this case, the mixed channel audio signal is multiplied by a weight value.

Thus, the processor 240 may control the audio processing unit 220 to provide the mixed audio signal, namely, an audio signal obtained by mixing the first, fourth, and fifth channel audio signals, to the first channel speaker and provide an audio signal obtained by mixing the second and fifth channel audio signals to the second channel speaker. In this case, the mixed audio signals, namely, the fourth channel audio signal and the fifth channel audio signal are directly provided to the fourth channel speaker and the fifth channel speaker, respectively.

In conclusion, in the above-described example, assuming that the first to fifth channel audio signals are a, b, c, d, and e, respectively, a signal of a+0.5*d+0.707*e is output from the first channel speaker, a signal of b+0.5*e is output from the second channel speaker, a signal of c is output from the third channel speaker, a signal of d is output from the fourth channel speaker, and a signal of e is output from the fifth channel speaker.

Meanwhile, according to an embodiment of the present disclosure, the processor 240 may control the audio processing unit 220 to multiply the mixed audio signal of the channel by a higher weight value as a distance between the speaker corresponding to the mixed audio signal of the channel and the listener increases, and mix the multiplied audio signal. That is, in the above-described example, audio signals mixed with the first channel audio signal are the fourth channel audio signal and the fifth channel audio signal. In this case, a speaker, which is farther from the listener from among the fourth channel speaker and the fifth channel speaker, is the fifth channel speaker. Accordingly, when the first channel audio signal is mixed with the fourth and fifth channel audio signals, the processor 240 may control the audio processing unit 220 to multiply the fifth channel audio signal by a higher weight value than a weight value by which the fourth channel audio signal is multiplied and mix the fourth and fifth channel audio signals with the first channel audio signal. Accordingly, as above described above, the processor 240 may control the audio processing unit 220 to multiply the fourth channel audio signal by a weight value of 0.5, multiply the fifth channel audio signal by a weight value of 0.707, and mix the fourth and fifth channel audio signals with the first channel audio signal. In this case, the weight values of 0.5 and 0.707 are only examples, and the present disclosure is not limited thereto.

As described above, an audio signal of a channel corresponding to a speaker that is close to the listener may be mixed with an audio signal of a channel corresponding to a speaker that is far from the listener, and the mixed audio signal may be output through the speaker that is close to the listener. Thus, an optimum audio listening environment may be provided irrespective of a position of the listener.

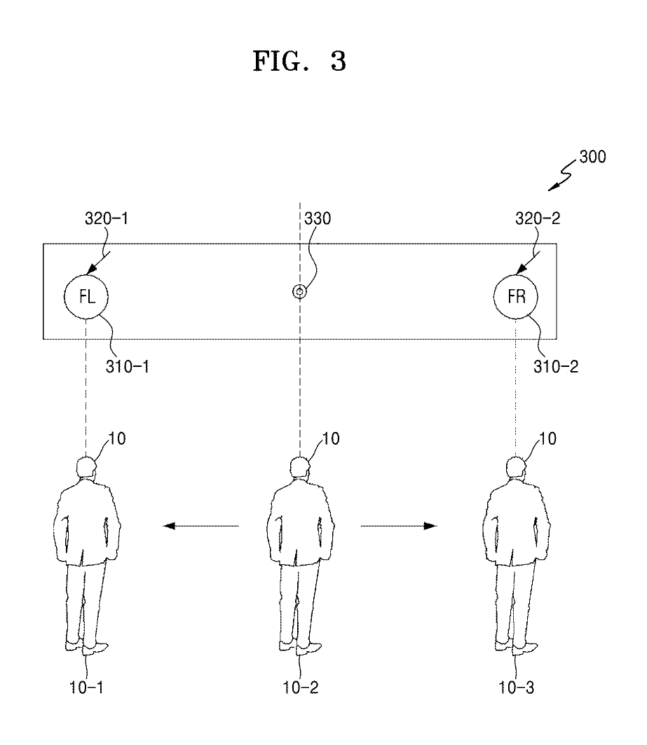

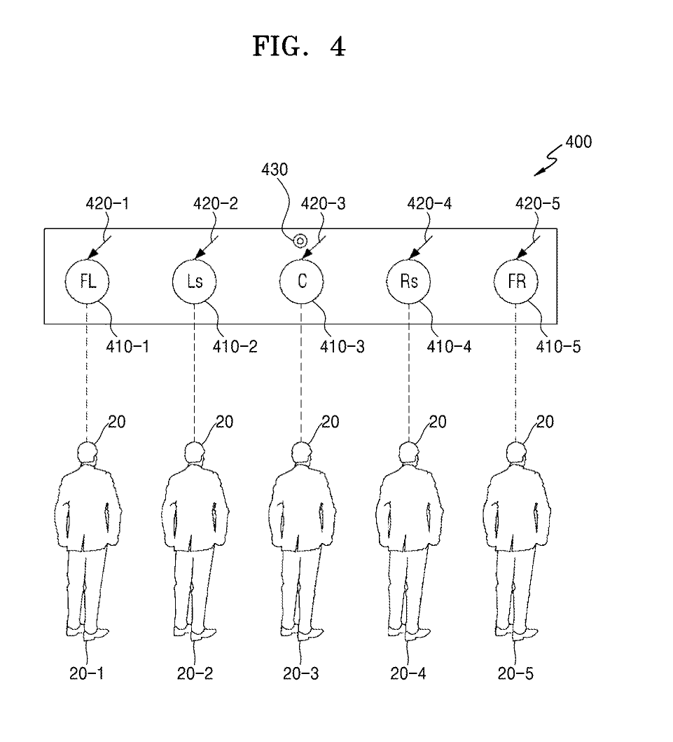

Hereinafter, operations of a processor 240 of an audio output device according to various embodiments of the present disclosure will be described in further detail with reference to FIGS. 3 and 4. FIG. 3 is an exemplary diagram of a sound bar 300 including a 2-channel speaker 320-1 and 320-2 according to an embodiment of the present disclosure.

As shown in FIG. 3, a left channel audio signal 320-1 is provided to a left channel speaker 310-1 of the audio output device 300, and a right channel audio signal 320-2 is provided to a right channel speaker 310-2. In this case, the audio output device 300 is installed such that a listener 10 may listen to optimum sound when the listener 10 is at a reference position 10.

In this situation, when a position of the listener is moved, the audio output device 300 may acquire position information of the listener using an image sensor 330, and determine a distance between each of the left channel speaker 310-1 and the right channel speaker 310-2 and the listener 10 based on the acquired position information.

When the listener 10 moves to a left side 10-1 from a reference position 10-2, a distance between the left channel speaker 310-1 and the listener is closer than a distance between the right channel speaker 310-2 and the listener 10. Thus, the audio output device 300 may mix the left channel audio signal 320-1 with the right channel audio signal 320-2, output the mixed audio signal through the left channel speaker 310-1, and directly output the right channel audio signal 320-2 to the right channel speaker 310-2.

If the listener moves to a right side 10-3 and is located relatively close to the right channel speaker 320-2, the audio output device 300 may mix the right channel audio signal 320-2 with the left channel audio signal 320-1, output the mixed audio signal through the right channel speaker 310-2, and directly output the left channel audio signal 320-1 to the left channel speaker 310-1.

When the listener 10 is located at the reference position 10-2, audio signals of respective channels are not mixed with each other but directly output.

FIG. 4 is an exemplary diagram of a sound bar 300 including a 5-channel speaker 410-1 to 410-5 according to an embodiment of the present disclosure.

As shown in FIG. 4, the 5-channel speaker 410-1 to 410-5 of the audio output device 400 includes a front left channel speaker 410-1, a left surround channel speaker 410-2, a center channel speaker 410-3, a right surround channel speaker 410-4, and a front right channel speaker 410-5, which are located in line in sequential order from the left. In this case, the audio output device 400 may be installed such that a listener 20 may listen to optimum sound when the listener 20 is at a reference position 20-3.

In this situation, when a position of the listener 20 is moved, the audio output device 400 may acquire position information of the listener using an image sensor 430, and determine a distance between each of the channel speakers 410-1 to 410-5 and the listener based on the acquired position information.

Thus, when the listener moves from the reference position 20-3 to a position 20-1 that is closest relatively to the front left channel speaker 410-1, the audio output device 400 may mix an audio signal 420-1 corresponding to the front left channel speaker 410-1 with an audio signal 420-4 corresponding to the right surround channel speaker 410-4 and an audio signal 420-5 corresponding to the front right channel speaker 410-5 and output the mixed signal through the front left channel speaker 410-1. The audio output device 400 may mix an audio signal 420-2 corresponding to the left surround channel speaker 410-2 with the audio signal 420-5 corresponding to the front right channel speaker 410-5 and output the mixed signal through the left surround channel speaker 410-2.

The audio signal 420-4 corresponding to the right surround channel speaker 410-4 and the audio signal 420-5 corresponding to the front right channel speaker 410-5, which are mixed with the audio signal 420-1 corresponding to the front left channel speaker 410-1, may be multiplied by weight values of 0.5 and 0.707, respectively, and mixed with the audio signal 420-1 corresponding to the front left channel speaker 410-1. Also, the audio signal 420-5 corresponding to the front right channel speaker 410-5, which is mixed with the audio signal 420-2 corresponding to the left surround channel speaker 410-2, may be multiplied by a weight value of 0.5 and mixed with the audio signal 420-2 corresponding to the left surround channel speaker 410-2.

Meanwhile, audio signals 420-3, 420-4, and 420-5 corresponding to the respective speakers 410-3, 410-4, and 410-5 may be directly output from the center channel speaker 410-3, the right surround channel speaker 410-4, and the front right channel speaker 410-5, respectively.

If the listener moves and is located closest to a position corresponding to the left surround channel speaker 410-2, the audio output device 400 may mix the audio signal 420-2 corresponding to the left surround channel speaker 410-2 with the audio signal 420-5 corresponding to the front right channel speaker 410-5 and output the mixed audio signal through the left surround channel speaker 410-2. In this case, the mixed audio signal 420-5 corresponding to the front right channel speaker 410-5 may be multiplied by a weight value of 0.5.

In this case, the audio signals 420-1, 420-3, 420-4, and 420-5 corresponding to the speakers 410-1, 410-3, 410-4, and 410-5 may be directly output from the front left channel speaker 410-1, the center channel speaker 410-3, the right surround channel speaker 410-4, and the front right channel speaker 410-5, respectively.

Meanwhile, when the listener moves and is located closest to the right front right channel speaker 410-5, the audio output device 400 may mix the audio signal 420-5 corresponding to the front right channel speaker 410-5 with the audio signal 420-4 corresponding to the left surround channel speaker 410-4 and the audio signal 420-1 corresponding to the front left channel speaker 410-1 and output the mixed audio signal through the front right channel speaker 410-5. Also, the audio output device 400 may mix the audio signal 420-4 corresponding to the right surround channel speaker 410-4 with the audio signal 420-1 corresponding to the front left channel speaker 410-1 and output the mixed audio signal through the right surround channel speaker 410-4.

In this case, the audio signal 420-2 corresponding to the left surround channel speaker 410-2 and the audio signal 420-1 corresponding to the front left channel speaker 410-1, which are mixed with the audio signal 420-5 corresponding to the front right channel speaker 410-5, may be multiplied by weight values of 0.5 and 0.707, respectively, and mixed with the audio signal 420-5 corresponding to the front right channel speaker 410-5. Also, the audio signal 420-1 corresponding to the front left channel speaker 410-1, which is mixed with the audio signal 420-4 corresponding to the right surround channel speaker 410-4, may be multiplied by a weight value of 0.5 and mixed with the audio signal 420-4 corresponding to the right surround channel speaker 410-4.

Meanwhile, the audio signals 420-3, 420-2, and 420-1 corresponding to the respective speakers 410-3, 410-2, and 410-1 may be directly output from the center channel speaker 410-3, the left surround channel speaker 410-2, and the front left channel speaker 410-1, respectively.

If the listener moves and is located closest to a position corresponding to the right surround channel speaker 410-4, the audio output device 400 may mix the audio signal 420-4 corresponding to the right surround channel speaker 410-4 with the audio signal 420-1 corresponding to the front left channel speaker 410-1 and output the mixed signal through the right surround channel speaker 410-4. In this case, the mixed audio signal 420-1 corresponding to the front left channel speaker 410-1 may be multiplied by a weight value of 0.5.

In this case, the audio signals 420-1, 420-2, 420-3, and 420-5 corresponding to the speakers 410-1, 410-2, 410-3, and 410-5 may be directly output from the front left channel speaker 410-1, the left surround channel speaker 410-2, the center channel speaker 410-3, and the front right channel speaker 410-5, respectively.

If the listener 20 is located at the reference position 20-3, the audio signals 420-1 to 420-5 of respective channels are not mixed with each other but directly output to the respective channel speakers 410-5. 410-5.

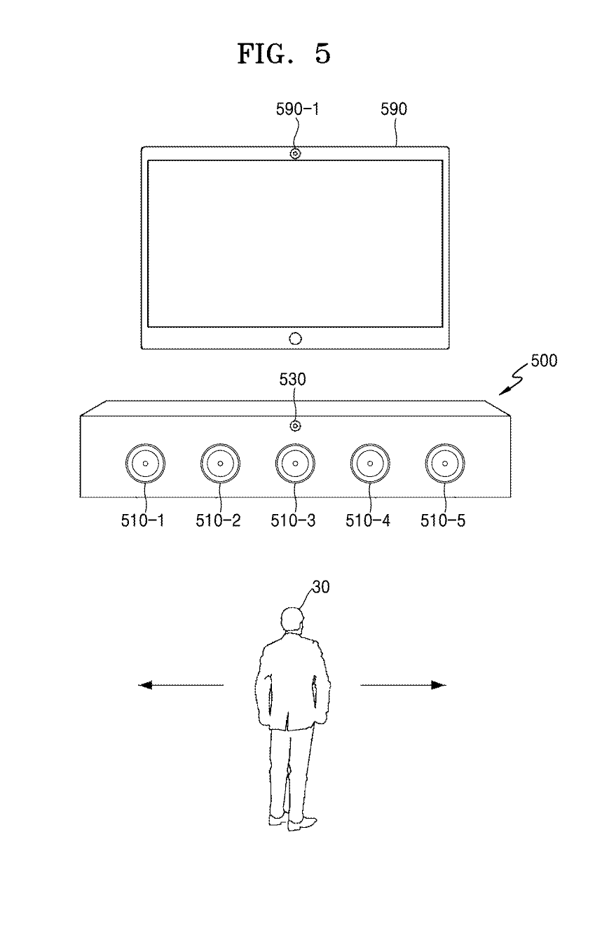

FIG. 5 is an exemplary diagram for describing an operation of an audio output device 500 according to another embodiment of the present disclosure. Referring to FIG. 5, the audio output device 500 is connected to and operates with an external display device 590. That is, a reproduced image of contents may be output by a display device 590, and a reproduced audio of contents may be synchronized with each other and output by the audio output device 500.

As shown in FIG. 5, five channel speakers 510-1 to 510-5 of the audio output device 500 are arranged in line in sequential order of first to fifth channel speakers 510-1 to 510-5, and a listener 30 is presently located at a reference position where the listener 30 may listen to optimum sound.

In this situation, when a position of the listener 30 is moved, the audio output device 500 acquires position information of the listener using an image sensor 530, and determines a distance between each of the channel speakers 510-1 to 510-5 and the listener based on the acquired position information.

Meanwhile, according to an embodiment of the present disclosure, the audio output device 500 may acquire the position information of the listener 30 using an image sensor 590-1 included in the display device 590 connected to the audio output device 500. Although not shown, as described above, the audio output device 500 may acquire the position information of the listener 30 using various other units, such as an IR signal, a Bluetooth signal, a WiFi signal, a GPS signal, and an RFID signal, other than the image sensors 530 and 590-1.

Thus, the audio output device 500 may mix an audio signal of a channel corresponding to a speaker close to the listener with an audio signal of a channel corresponding to a speaker far from the listener and output the mixed audio signal through the speaker close to the listener. As a result, the audio output device 500 may provide an optimum audio listening environment irrespective of a position of the listener.

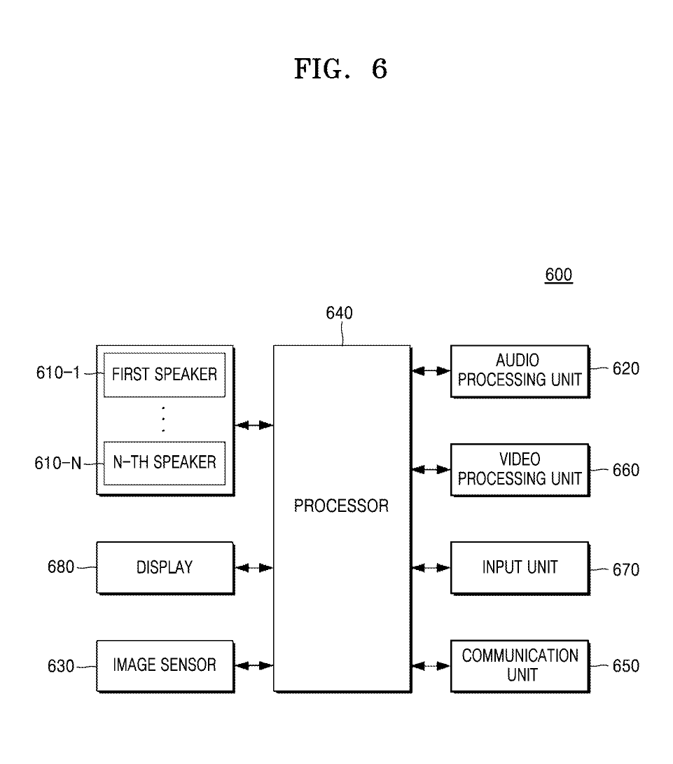

FIG. 6 is a detailed block diagram of a configuration of an audio output device according to another embodiment of the present disclosure. Referring to FIG. 6, an audio output device 600 includes a plurality of speakers 610, an audio processing unit 620, an image sensor 630, a processor 640, a communication unit 650, a video processing unit 660, an input unit 670, and a display 680. In this case, the audio output device 600 may be a display device, such as a television (TV) or an electronic frame, but the present disclosure is not limited thereto.

Meanwhile, in FIG. 6, since the plurality of speakers 610, the audio processing unit 620, the image sensor 630, and the communication unit 650 perform the same operations as the plurality of speakers 110 and 210, the audio processing units 120 and 220, the image sensor 230, and the communication unit 350 described with reference to FIGS. 1 and 2, repeated descriptions thereof will be omitted below. Also, since the processor 640 also performs the same operation as the processors 140 and 240, repeated descriptions thereof will be omitted.

The input unit 670 may be a component configured to receive a user manipulation command for manipulating the audio output device 600. Particularly, when a plurality of listeners are present as described below, the input unit 670 may receive a user selection command for selecting a listener, on a user interface (UI) configured to select a listener to acquire position information. To this end, the input unit 670 may be implemented as including a button, a touch panel (when the display 680 is implemented as a touch screen), or a remote control signal receiving unit (not shown, when the audio output device 600 is controlled by an external remote controller), which is included in the audio output device 600.

The display 680 may display various images, which are input from various sources. Specifically, the display 680 may display images included in various contents acquired from a broadcasting station, an external server, an external device (a CD or DVD player or the like), or the like. In particular, the display 680 may display a UI configured to select a listener to acquire various images processed by the video processing unit 660 and position information via the control of the processor 640.

The video processing unit 660 performs an image processing operation on various images to be displayed via the display 680. Specifically, the video processing unit 680 may perform various image processing operations, such as a decoding operation, a scaling operation, a noise filtering operation, a frame rate conversion (FRC) operation, and a resolution conversion operation, on image data included in contents received from various sources.

When an image frame including a plurality of listeners is acquired from the image sensor 630, the processor 640 may analyze the image frame and determine whether listeners are plural or not. In this case, the processor 640 may control the audio processing unit 620 not to mix audio signals of channels corresponding to the plurality of speakers 640 with each other.

This is because it is unclear as to which listener is to be used as a basis for determining a distance between the listener and the plurality of speakers 610 when a plurality of listeners are present, and other listeners may be subject to poor audio environments when an audio signal of a channel is mixed with an audio signal of another channel on the basis of a specific listener.

Meanwhile, according to another embodiment of the present disclosure, when a plurality of listeners are present, the processor 640 may select a specific listener based on predetermined criteria and control the audio processing unit 620 to mix audio signals on the basis of the selected listener.

For example, when it is determined that the plurality of listeners are present, the processor 640 may control the display 680 to display a UI (hereinafter, referred to as a listener selection UI) for selecting a listener that serves as a basis for mixing audio signals, from among the plurality of listeners. The UI may include information capable of discrimination between the respective listeners included in the acquired image frame, for example, a face of each of the plurality of listeners. However, the present disclosure is not limited thereto.

Thus, when a listener selection command of a user is input on the listener selection UI through the input unit 670, the processor 640 may control the image sensor 630 to acquire position information of the selected listener.

Meanwhile, as described above, the position information of the listener may be acquired using signals transmitted from an external apparatus, such as a remote controller, a cellphone, an electronic watch, and the like. Thus, in this case, the processor 640 may acquire position information of a listener that carries the corresponding external apparatus, so that a listener to acquire position information may be selected from among the plurality of listeners.

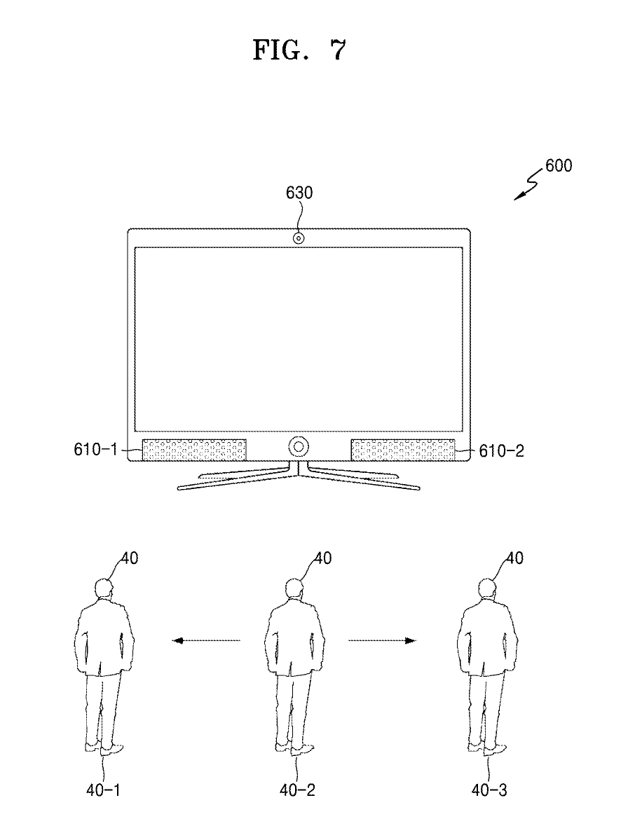

FIG. 7 is an exemplary diagram of an audio output device including the same configuration as that of FIG. 6. That is, FIG. 7 illustrates a case in which an audio output device 600 is implemented as a display device. The audio output device 600 shown in FIG. 7 includes a 2-channel stereo speaker, namely, a left channel speaker 610-1 and a right channel speaker 610-2. In this case, a middle position 40-2 between the left channel speaker 610-1 and the right channel speaker 610-2 becomes a reference position, and the listener 40 may listen to a sound source reproduced by the audio output device 600 with optimum sound at the reference position.

In this situation, when the listener 40 moves to a position 40-1 close to the left channel speaker 610-1, the listener listens to a right channel audio output signal having a lower magnitude than at the reference position 40-2.

To supplement this point, when the position information of the listener at a position 40-1 close to the left channel speaker 610-1 is acquired using the image sensor 630, the audio output device 600 according to the embodiment of the present disclosure mixes an audio signal corresponding to the left channel speaker 610-1, which is close to the listener, with an audio signal corresponding to the right channel speaker 610-2, which is an audio signal of another channel, and outputs the mixed audio signal. In this case, the mixed audio signal corresponding to the right channel speaker 610-2 may be multiplied by a weight value. Meanwhile, the audio output device 600 directly outputs the audio signal corresponding to the right channel speaker 610-2 to the right channel speaker 610-2.

As described above, an audio signal of a channel, which is relatively away from the listener due to the movement of the listener, sounds small and is mixed with an audio signal of a channel that is relatively close to the listener, and the mixed audio signal is output through a speaker of the channel that is relatively close to the listener. Accordingly, the listener may be provided with optimum sound at any sound regardless of a position of the listener.

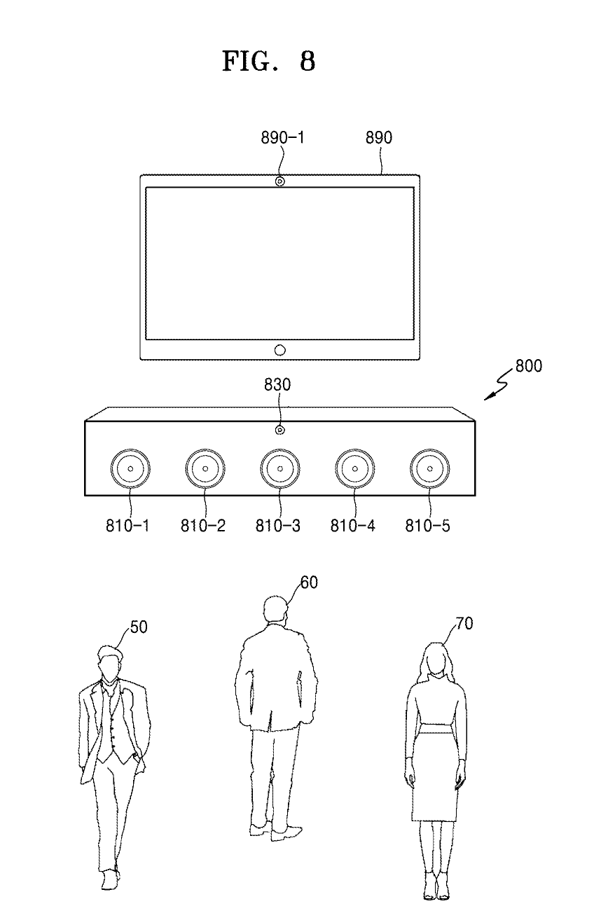

FIG. 8 is an exemplary diagram for describing an operation of an audio output device 800 according to an embodiment of the present disclosure when a plurality of listeners are present. Referring to FIG. 8, an audio output device 800 including a 5-channel speaker 810-1 to 810-5 is connected to an external display device 890 to constitute an audio-video (AV) system.

In this case, for example, when broadcasting contents are reproduced through the AV system, images included in the broadcasting contents may be displayed on the display device 890, and sound included in the broadcasting contents may be reproduced by the audio output device 800.

In this case, when an image frame is acquired by an image sensor 830, the audio output device 800 may analyze the acquired image frame and determine whether a plurality of listeners 50, 60, and 70 are present. Meanwhile, in some embodiments, an image including a plurality of listeners may be acquired by an image sensor 890-1 included in the display device 800 and provided to the audio output device 800.

In this case, according to an embodiment of the present disclosure, the audio output devices 100 and 200 may not mix audio signals corresponding to respective channels but directly output the audio signals corresponding to the respective channels to five channel speakers 810-1 to 810-5, respectively.

Meanwhile, according to another embodiment of the present disclosure, the audio output device 830 may acquire position information of a listener selected via a listener selection user interface (UI) displayed on the display device 890, using the image sensor 830 or 890-1, mix audio signals on the basis of the corresponding listener, and output the mixed audio signal. For example, when a listener 50 is selected, the audio output device 800 may multiply an audio signal corresponding to the channel speaker 810-1, which is closest to the listener 50, and audio signals corresponding to other channel speakers 810-4 and 810-5 by weight values, mix the multiplied audio signals, and output the mixed audio signal through the channel speaker 810-1, which is closest to the listener 50. Also, the audio output device 800 may multiply an audio signal corresponding to the channel speaker 810-2, which is second closest to the listener 50, and an audio signal corresponding to another channel speaker 810-5 by weight values, mix the multiplied audio signals, and output the mixed audio signal through the channel speaker 810-2, which is second closest to the listener 50. In this case, audio signals corresponding to the respective channel speakers 810-3, 810-4, and 810-5 may be directly output from the channel speakers 810-3, 810-4, and 810-5.

Meanwhile, according to an embodiment of the present disclosure, the position information of the listener may be acquired using an external apparatus carried by the listener. In the example of FIG. 8, if the listener 50 carries a specific cellphone, even if it is determined using the image sensor 830 or 890-1 that a plurality of listeners are present, the audio output device 800 may acquire position information of the listener 50 that carries the specific external apparatus, and mix and output audio signals on the basis of a position of the listener 50.

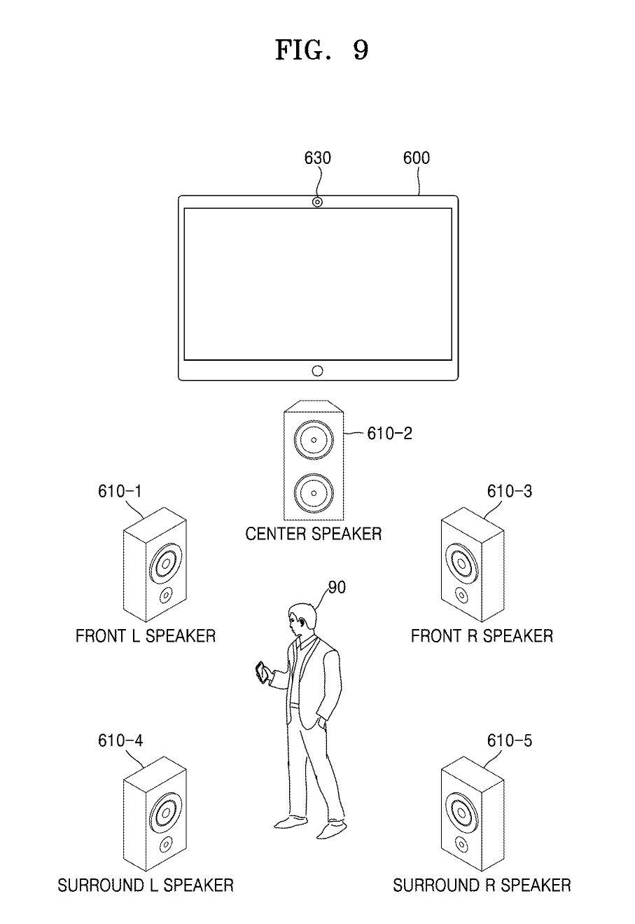

FIG. 9 is an exemplary diagram for describing an operation of an audio output device according to an embodiment of the present disclosure when a plurality of speakers are located on a space. As shown in FIG. 9, a plurality of speakers 610 from among components of an audio output device 600 may be separately located outside. That is, the audio output device 600, a front L speaker 610-1, a center speaker 610-2, a front R speaker 610-3, a surround L speaker 610-4, and a surround R speaker 610-5 may be located as shown in FIG. 9.

Thus, even when the plurality of speakers 110, 210, and 610 according to various embodiments of the present disclosure are not located in line but located on a space, the spirit of the present disclosure may be directly applied.

That is, the audio output device 600 may determine a distance between each of the plurality of speakers 610-1 to 610-5 and a listener 90 based on position information of the listener 90, which is acquired by an image sensor 630 or a communication unit (650, not shown). Thus, the audio output device 600 may mix an audio signal of a channel corresponding to at least one speaker, which is relatively close to the listener 90 from among the plurality of speakers 610-1 to 610-5, with an audio signal of another channel and output the mixed audio signal through the at least one speaker. In this case, the mixed audio signal of the channel may be multiplied by a weight value, mixed, and directly output to a speaker of a channel corresponding to the mixed audio signal of the channel.

FIG. 9 illustrates a case in which a listener 90 presently stands at a reference position. If the listener 90 moves toward the front L speaker 610-1, the audio output device 600 may multiply audio signals of channels corresponding to the front R speaker 610-3 and the surround R speaker 610-5, which become relatively far from the listener 90, by weight values and mix the multiplied audio signals with an audio signal corresponding to the front L speaker 610-1. Thus, the audio output device 600 may output the mixed audio signals to the front L speaker 610-1 and directly output audio signals corresponding to the corresponding speakers to the remaining speakers 610-2 to 620-5.

Thus, as shown in FIG. 9, even if a plurality of speakers configured to output an audio signal having a plurality of channels are located on a space, the listener may listen to optimum sound provided by an audio output device regardless of a change in position of the listener.

Meanwhile, a case in which the audio output devices 100 to 600 and 800 include or are connected to a 2-channel speaker or a 5-channel speaker has been described as an example, but the present disclosure is not limited thereto. For example, the audio output devices 100 to 600 and 800 may include a plurality of speakers (e.g., a 5.1-channel speaker, a 7.1-channel speaker, and the like), which further includes a woofer speaker. That is, the number of speakers or the number of channels is not limited as long as the speakers or the channels are plural.

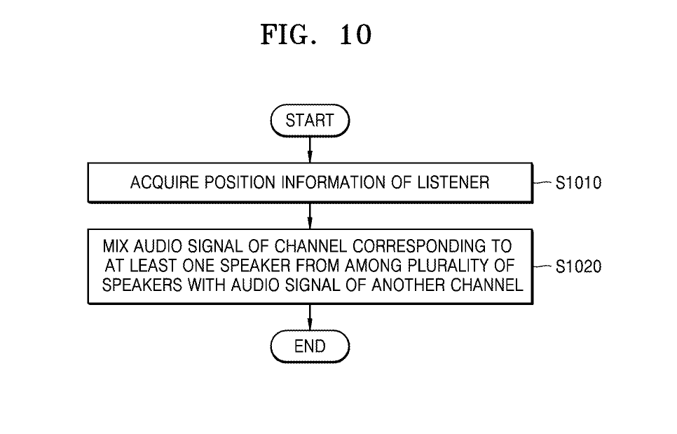

FIG. 10 is a flowchart of a method of controlling an audio output device according to an embodiment of the present disclosure. Referring to FIG. 10, the audio output devices 100 to 600 and 800 may acquire position information of a listener (S1010). Specifically, the audio output devices 100 to 600 and 800 may acquire the position information of the listener using a signal of an image sensor or a specific external apparatus (e.g., an electronic device) carried by the listener.

In addition, according to another embodiment of the present disclosure, when a plurality of listeners are present, the audio output devices 100 to 600 and 800 may select a listener to acquire position information, from a plurality of listeners, according to predetermined criteria. Specifically, the audio output devices 100 to 600 and 800 may select the listener to acquire the position information, on the basis of a user selection command for selecting the listener to acquire the position information or a position of the specific external apparatus. Thus, the audio output devices 100 to 600 and 800 may acquire position information of the selected listener.

Meanwhile, the audio output devices 100 to 600 and 800 may mix an audio signal of a channel corresponding to at least one speaker from among a plurality of speakers with an audio signal of another channel based on the acquired position information (S1020). Specifically, the audio output devices 100 to 600 and 800 may determine a distance between each of the plurality of speakers and the listener using the position information of the listener. Accordingly, the audio output devices 100 to 600 and 800 may mix an audio signal of a channel corresponding to at least one speaker, which is relatively close to the listener from among the plurality of speakers, with an audio signal of another channel.

For example, the audio output devices 100 to 600 and 800 may include a 2-channel speaker including a left channel speaker and a right channel speaker. In this case, the audio output devices 100 to 600 and 800 may mix an audio signal of a left channel with an audio signal of a right channel when the listener is located relatively closest to the left channel speaker, and mix the audio signal of the right channel with the audio signal of the left channel when the listener is located relatively closest to the right channel speaker.

In another example, the audio output devices 100 to 600 and 800 may include a 5-channel speaker including first to fifth channel speakers arranged in line in sequential order. In this case, the audio output devices 100 to 600 and 800 may mix an audio signal of a first channel with audio signals of a fourth channel and a fifth channel and mix an audio signal of a second channel with the audio signal of the fifth channel when the listener is located relatively closest to the first channel speaker, and mix the audio signal of the second channel with the audio signal of the fifth channel when the listener is located relatively closest to the second channel speaker.

In this case, as a distance between a speaker corresponding to the mixed audio signal of the another channel increases, the audio output devices 100 to 600 and 800 may multiply the audio signal of the another channel by a higher weight value and mix the multiplied audio signal.

Thus, the audio output devices 100 to 600 and 800 may provide the mixed audio signal to the at least one speaker, and provide the audio signal of the another channel to a speaker corresponding to the audio signal of the another channel.

Meanwhile, according to another embodiment of the present disclosure, when a plurality of listeners are present, the audio output devices 100 to 600 and 800 may not mix the audio signal of the another channel.

According to various embodiments of the present disclosure as described above, even if a position of the listener is changed, the listener may listen to optimum sound provided by an audio output device at the changed position.

Meanwhile, operations of the processors 140, 240, and 640 of the audio output devices 100, 200, and 600, operations of the audio output devices 100 to 600 and 800, and methods of controlling the audio output devices 100 to 600 and 800, according to the above-described various embodiments, may be generated in software and mounted on an electronic device 100. For example, a non-transitory computer readable medium having recorded thereon a program for performing a method of controlling an audio output device including an operation of acquiring position information of a listener and an operation of mixing an audio signal of a channel corresponding to at least one speaker from among a plurality of speakers with an audio signal of another channel based on the position information of the listener may be installed.

Here, the non-transitory computer readable medium is not a medium (e.g., a register, a cache, a memory, and the like) configured to store data for a short period of time but refers to a medium capable of semi-permanently storing data and being read using an apparatus. Specifically, the above-described various middleware or programs may be stored and provided in a non-transitory computer readable medium, such as a CD, a DVD, a hard disk, a blue-ray disk, a USB, a memory card, a read-only memory (ROM), and the like.

While the above descriptions are merely illustrative of the spirit of the present disclosure, various changes and modifications may be made by one skilled in the art without departing from essential characteristics of the present disclosure. Also, embodiments of the present disclosure are not intended to limit the scope of the present disclosure, but to be illustrative, and the scope of the spirit of the present disclosure is not limited by the embodiments. Accordingly, the scope of the present disclosure should be construed by the following claims, and all technical ideas within the scope of equivalents thereof should be construed as being included in the scope of the present disclosure.

1. An audio output device comprising:
an audio processing unit configured to process an audio signal having a plurality of channels;
a plurality of speakers configured to output the processed audio signal having the plurality of channels;
a position information acquisition unit configured to acquire position information of a listener; and
a processor configured to control the audio processing unit to mix an audio signal of a channel corresponding to at least one speaker from among the plurality of speakers with an audio signal of another channel based on the position information of the listener.

2. The audio output device of claim 1, wherein the processor determines a distance between each of the plurality of speakers and the listener using the position information of the listener, and controls the audio processing unit to mix an audio signal of a channel corresponding to at least one speaker, which is relatively close to the listener from among the plurality of speakers, with the audio signal of the another channel.

3. The audio output device of claim 2, wherein the processor controls the audio processing unit to multiply the audio signal of the another channel by a higher weight as a distance between a speaker corresponding to the audio signal of the another channel and the listener increases, and mix the multiplied audio signal.

4. The audio output device of claim 1, wherein the processor controls the audio processing unit to provide the mixed audio signal to the at least one speaker and provide the audio signal of the another channel to a speaker corresponding to the another channel.

5. The audio output device of claim 2, wherein the plurality of channels are two channels, the plurality of speakers comprise a left channel speaker and a right channel speaker, and the processor controls the audio processing unit to mix an audio signal of the left channel with an audio signal of the right channel if the listener is located relatively close to the left channel speaker, and mix the audio signal of the right channel with the audio signal of the left channel if the listener is located relatively close to the right channel speaker.

6. The audio output device of claim 2, wherein the plurality of channels are five channels, the plurality of speakers comprise first to fifth channel speakers arranged in line in sequential order, and the processor controls the audio processing unit to mix an audio signal of the first channel with audio signals of fourth and fifth channels and mix an audio signal of the second channel with the audio signal of the fifth channel if the listener is located closest to the first channel speaker, and controls the audio processing unit to mix the audio signal of the second channel with the audio signal of the fifth channel if the listener is located closest to the second channel speaker.

7. The audio output device of claim 1, wherein if a plurality of listeners are present, the processor controls the audio processing unit not to mix the audio signal of the another channel.

8. The audio output device of claim 1, wherein if a plurality of listeners are present, the processor selects a listener to acquire the position information, from among the plurality of listeners, according to predetermined criteria and controls the position information acquisition unit to acquire position information of the selected listener.

9. The audio output device of claim 7, wherein the processor selects the listener to acquire the position information on the basis of a user selection command for selecting the listener to acquire the position information or a position of a specific external apparatus.

10. A method of controlling an audio output device comprising a plurality of speakers corresponding to a plurality of channels, the method comprising:
acquiring position information of a listener; and
mixing an audio signal of a channel corresponding to at least one speaker from among the plurality of speakers with an audio signal of another channel based on the position information of the listener.

11. The method of claim 10, wherein the mixing of the audio signals comprises:
determining a distance between each of the plurality of speakers and the listener using the position information of the listener; and
mixing an audio signal of a channel corresponding to at least one speaker, which is relatively close to the listener from among the plurality of speakers, with the audio signal of the another channel.

12. The method of claim 11, wherein the mixing of the audio signals comprises multiplying the audio signal of the another channel by a higher weight as a distance between a speaker corresponding to the audio signal of the another channel and the listener increases, and mixing the multiplied audio signal.

13. The method of claim 10, further comprising providing the mixed audio signal to the at least one speaker and providing the audio signal of the another channel to a speaker corresponding to the another channel.

14. The method of claim 11, wherein the plurality of channels are two channels, the plurality of speakers comprise a left channel speaker and a right channel speaker, and the mixing of the audio signals comprises mixing an audio signal of the left channel with an audio signal of the right channel if the listener is located relatively close to the left channel speaker and mixing the audio signal of the right channel with the audio signal of the left channel if the listener is located relatively close to the right channel speaker.

15. The method of claim 11, wherein the plurality of channels are five channels, the plurality of speakers comprise first to fifth channel speakers arranged in line in sequential order, and the mixing of the audio signals comprises mixing an audio signal of the first channel with audio signals of fourth and fifth channels and mixing an audio signal of the second channel with the audio signal of the fifth channel if the listener is located closest to the first channel speaker, and mixing the audio signal of the second channel with the audio signal of the fifth channel if the listener is located closest to the second channel speaker.
